(19) United States
(12) Patent Application Publication
(10) Pub. No.: US 2015/0086023 A1
(43) Pub. Date: Mar. 26, 2015

(54) AUDIO CONTROL APPARATUS AND METHOD

(71) Applicant: KABUSHIKI KAISHA TOSHIBA, Tokyo (JP)

(72) Inventors: Akihiko ENAMITO, Kawasaki (JP); Keiichiro SOMEDA, Yokohama (JP)

(21) Appl. No.: 14/495,084

(22) Filed: Sep. 24, 2014

(30) Foreign Application Priority Data
Sep. 24, 2013 (JP) 2013-197603

(51) Int. Cl. H04R 5/04

(52) U.S. Cl. CPC H04R 5/04
USPC 381/17

(57) ABSTRACT

According to an embodiment, an audio control apparatus includes a calculation unit and a determination unit. The calculation unit is configured to calculate an interaural cross-correlation function of a binaural recording signal at regular time intervals. The determination unit is configured to determine that a signal zone in which peak times of interaural cross-correlation functions are consecutively included in one of a plurality of time ranges determined in advance is a localized-sound zone in which a sound-image is localized, each of the peak times being a time at which a corresponding cross-correlation function takes a maximum value.

### CROSS-REFERENCE TO RELATED APPLICATIONS

This application is based upon and claims the benefit of priority from Japanese Patent Application No. 2013-197603, filed Sep. 24, 2013, the entire contents of which are incorporated herein by reference.

### FIELD

Embodiments described herein relate generally to an audio control apparatus and method.

### BACKGROUND

A binaural recording technique of recording a three-dimensional sound by using two microphones exists. Furthermore, a signal processing technique for reproducing a three-dimensional sound by using a binaural recording signal by means of earphones or speakers also exists.

However, the transaural reproduction technique of reproducing a three-dimensional sound by using speakers is, unlike the binaural reproduction technique using earphones, carried out based on accurate recording, signal processing, and an analytical method, all of which are to be carried out by video/audio engineers, and is not intended for general users (nonprofessionals).

A binaural recording signal acquired by general users by using binaural earphones has poor sound quality due to ambient noise superimposed thereon, and is a sound source in which a background sound and a localized sound having a sound-image localization sensation are intermingled. Accordingly, when the binaural recording signal is reproduced as-is, the reproduction performance is poor as a three-dimensional sound. Supposing that only a localized sound having a sound-image localization sensation can be recorded, it is not always possible to reproduce a reproduction sound image in the same direction as the direction in which the user has heard and felt the sound. Therefore, when a sound recorded outdoors is reproduced, it is not always possible to feel a bodily sensation of realism or immersion.

A technique which is intended for a binaural recording signal recorded by general users, and makes it possible to edit a binaural recording signal in such a manner that a sound image is localized in a desired direction, is desired. In order to facilitate editing of a binaural recording signal, it is required that a signal zone including a localized sound be able to be extracted from a binaural recording signal.

### BRIEF DESCRIPTION OF THE DRAWINGS

FIG. 1 is a block diagram schematically showing an audio control apparatus according to an embodiment.

FIGS. 2A and 2B are views for explaining an outline of aninteraural cross-correlation function.

FIG. 3 is a view showing a relationship between angles and directions in accordance with an embodiment.

FIG. 4 is a view for explaining an analysis method of the interaural cross-correlation function.

FIG. 5 is a view showing an example of an analysis result of a binaural recording signal.

FIG. 6 is a view showing an example of an analysis result of a binaural recording signal.

FIG. 7 is a view showing an example of an analysis result of a binaural recording signal.

FIG. 8 is a view showing an example of an analysis result of a binaural recording signal.

FIG. 9 is a view showing an example of an analysis result of a binaural recording signal.

FIG. 10 is a view showing an example of an analysis result of a binaural recording signal.

FIG. 11 is a view showing an example of an analysis result of a binaural recording signal.

FIG. 12 is a view showing an example of an analysis result of a binaural recording signal.

FIG. 13 is a view showing an example of an analysis result of a binaural recording signal.

FIG. 14 is a view showing an example of an analysis result of a binaural recording signal.

FIG. 15 is a view showing an example of an analysis result of a binaural recording signal.

FIG. 16 is a view showing an example of an analysis result of a binaural recording signal.

FIG. 17 is a view showing an example of a screen displayed by a display unit shown in FIG. 1.

FIG. 18 is a view showing an example of a signal generator shown in FIG. 1.

FIG. 19 is a view showing another example of the signal generator shown in FIG. 1.

FIG. 20 is a view showing an example of a method of specifying an emphasis degree in accordance with an embodiment.

FIG. 21 is a flowchart showing an example of a processing procedure of the audio control apparatus of FIG. 1.

### DETAILED DESCRIPTION

In general, according to an embodiment, an audio control apparatus includes a calculation unit and a determination unit. The calculation unit is configured to calculate an interaural cross-correlation function of a binaural recording signal at regular time intervals. The determination unit is configured to determine that a signal zone in which peak times of interaural cross-correlation functions are consecutively included in one of a plurality of time ranges determined in advance is a localized-sound zone in which a sound-image is localized, each of the peak times being a time at which a corresponding cross-correlation function takes a maximum value.

Hereinafter, embodiments will be described with reference to the accompanying drawings. In the following embodiment, like reference numbers denote like elements, and a repetitive explanation will be omitted.

A binaural recording signal is a two-channel audio signal recorded by microphones mounted on auricles of both ears of a model simulating a head-ear shape called a dummy head or binaural microphones (microphones mounted on earphones). Unlike a two-channel audio signal obtained by using ordinary two-channel stereo microphones (two microphones arranged separate from each other), the binaural recording signal is an audio signal to which influences of auricles of the head and a distance between both ears are added, and hence when a sound obtained by reproducing a binaural recording signal is heard by using earphones, the sound is heard as a three-dimensional sound.

When a binaural recording signal recorded outdoors is reproduced and heard by using earphones, it is understood that the reproduced sound is roughly divided into a background sound (for example, a sound from a sound source with an unknown sound-source position such as sounds of a busy street, wind sounds, and the like) with a surround sensation, and a localized sound (for example, a sound a sound-source position and strength of which can be ascertained such as a voice of a person, chirping of a bird, and the like) from which a sound image can be perceived. However, regarding the latter, a sound image perceived at the site is not always reproduced with fidelity, as in the case where the sound that should have been perceived at the recording site is heard as being blurred in the reproduced sound, or is heard from a totally different direction. Although this may be due to the manner of recording or may be due to an influence of the environmental noise of the recording site, even when a case where an absence of background noise is assumed, a localization sensation is not always adequately reproduced. Further, for example, when a recording is made in a forest setting where a bird is singing loudly just beside the microphone position, it is desirable at the time of three-dimensional sound reproduction, in consideration of the overall balance and the importance of the user's impression, that the sound of the bird singing loudly should not be reproduced to sound as if it is at exactly the same position, but that the bird's sound should come from a location such as a diagonal rearward direction. It is difficult to carry out rearward localization in the three-dimensional sound reproduction using speakers. Therefore, even when it is assumed that a localized sound existing in a rearward direction could have been recorded adequately, the localized sound recorded is not reproduced with fidelity in some cases. In such a case, it is possible at the time of three-dimensional sound reproduction to reproduce the localized sound and give the user the image of the localized sound, even though the direction is different, by changing the direction of the recorded localized sound and redefining the localized sound in the forward direction. As described above, the presence of a localized sound is important in providing a desired sound space to the user.

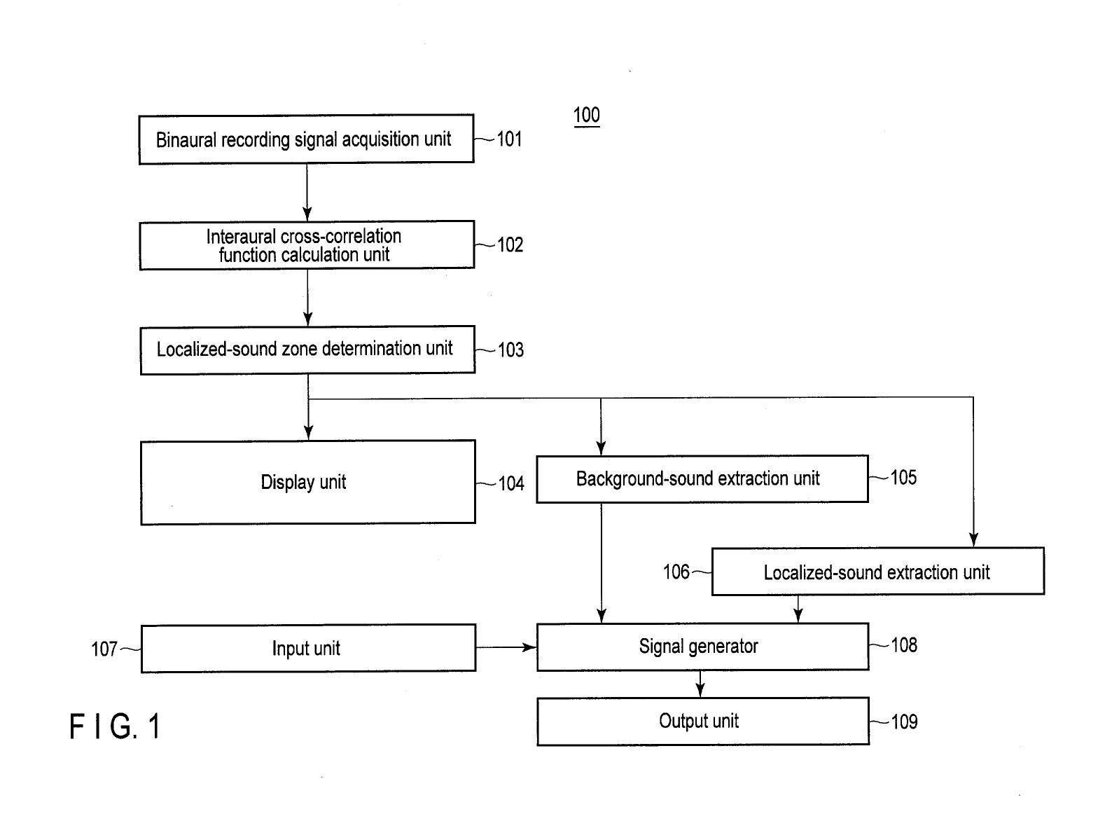

FIG. 1 schematically shows an audio control apparatus 100 according to an embodiment. As shown in FIG. 1, the audio control apparatus 100 includes a binaural recording signal acquisition unit 101, an interaural cross-correlation function calculation unit 102, a localized-sound zone determination unit 103, a display unit 104, a background-sound extraction unit 105, a localized-sound extraction unit 106, an input unit 107, a signal generator 108, and an output unit 109. Hereinafter, the binaural recording signal acquisition unit 101, the interaural cross-correlation function calculation unit 102, and the localized-sound zone determination unit 103 are simply referred to as the acquisition unit 101, the calculation unit 102, and the determination unit 103, respectively.

The acquisition unit 101 acquires a binaural recording signal. For example, the acquisition unit 101 acquires from an external device a binaural recording signal previously recorded by a general user.

The calculation unit 102 calculates an interaural cross-correlation function (IACF) of the binaural recording signal at regular time intervals ΔT. The interaural cross-correlation function can be expressed as shown by the following formula (1).

$$IACF ( τ ) = \frac{{\int }_{t 1}^{t 2} {P}_{L} ( t ) {P}_{R} ( t + τ ) d t}{\sqrt{{\int }_{t 1}^{t 2} {P}_{L}^{2} ( t ) d t \cdot {\int }_{t 1}^{t 2} {P}_{R}^{2} ( t ) d t}} \qquad ( 1 )$$

Here, P_{L}(t) denotes a sound pressure entering a left ear at time t, and P_{R}(t) denotes a sound pressure entering a right ear at time t. Each of t1 and t2 denotes a measurement time, and t1 is 0 (t1=0), and t2 is ∞ (t2=∞). In the actual calculation, it is sufficient if t2 is set to a measurement time approximately equal to a reverberation time and t2 is set to, for example, 100 msec. τ denotes a correlation time, and the range of the correlation time is set to, for example, a range from −1 msec to 1 msec. Accordingly, it is necessary to set the time interval ΔT on the signal at which the interaural cross-correlation functions are calculated equal to or longer than a measurement time. In this embodiment, the time interval ΔT is 0.1 sec.

The calculation unit 102 outputs information including a correlation time (peak time) τ(i) at which the interaural cross-correlation function takes the maximum value, and the maximum value (intensity level) γ(i). The intensity level indicates to what degree the sound-pressure waveforms transmitted to both ears coincide with each other. The value i indicates an order in which interaural cross-correlation functions are calculated, and is information used to specify a temporal position on the binaural recording signal.

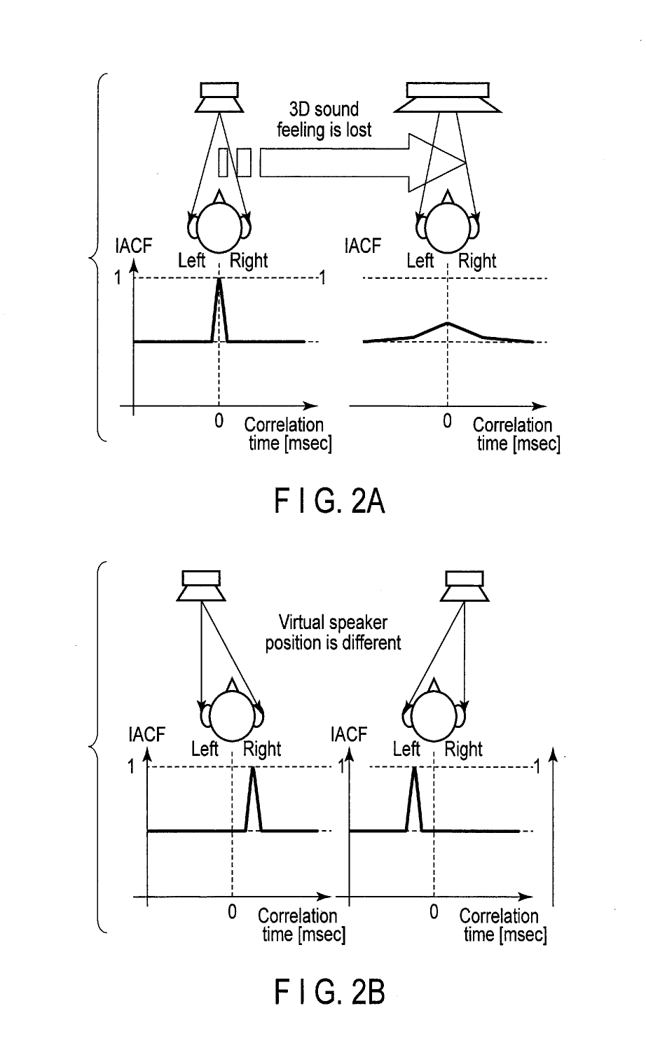

FIG. 2A shows a relationship between the intensity level and the localization sensation of a sound image, and FIG. 2B shows a relationship between the correlation time and the direction (sound-image direction) in which a sound image is localized. As shown in FIG. 2A, when the intensity is high, the sound-image localization sensation is strong. Conversely, when the intensity is low, the sound-image localization sensation is weak, i.e., the sound image is blurred. As shown in FIG. 2B, when a sound image exists on the right side, a peak appears at a negative time. Conversely, when a sound image exists on the left side, a peak appears at a positive time.

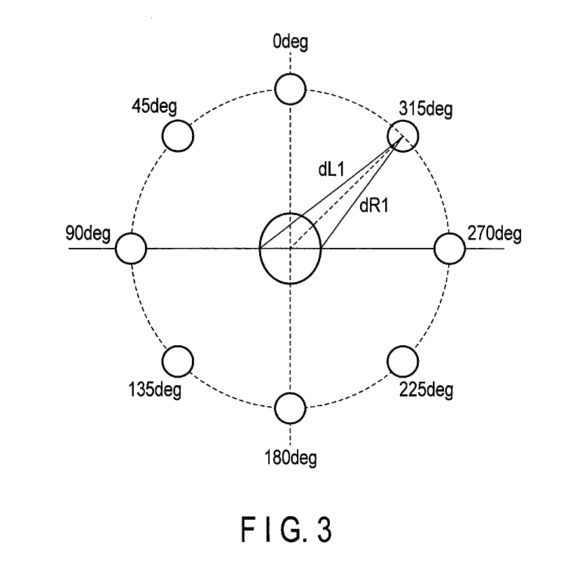

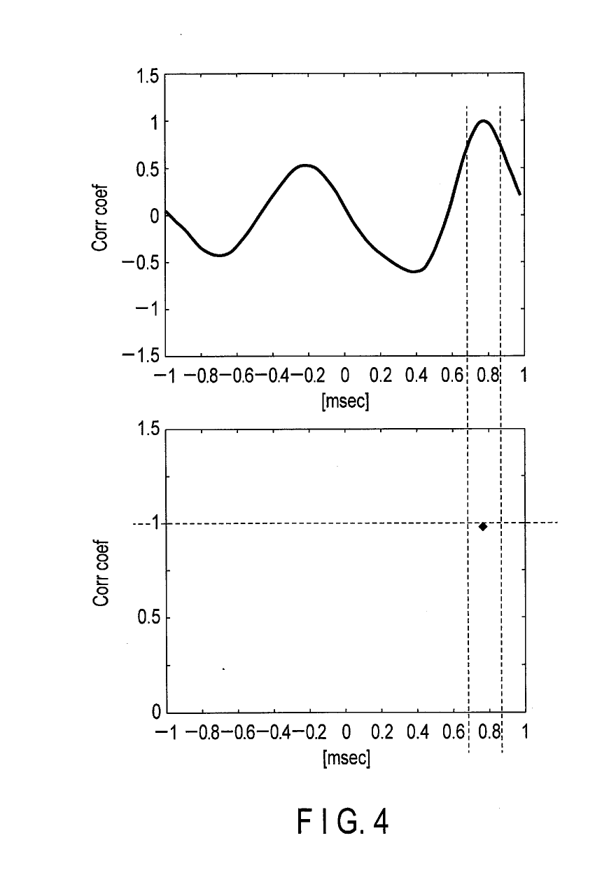

In this embodiment, as shown in FIG. 3, assuming that a position right in front of the listener (user) is 0°, angular positions are set in the counterclockwise direction. For example, the direction of 90° corresponds to the left side, direction of 180° corresponds to the rear, and direction of 270° corresponds to the right side. FIG. 4 shows a result of calculating an interaural cross-correlation function for a binaural recording signal obtained by recording a sound generated from a sound source arranged in the direction of 90° (left side). As shown in the graph on the upper side of FIG. 4, the interaural cross-correlation function has the maximum value at a correlation time of about 0.8 msec. In the graph on the lower side of FIG. 4, a data point corresponding to the maximum value (i.e., the intensity level) of the interaural cross-correlation function is plotted. The intensity level is a value less than or equal to 1.

When a sound-image direction is to be specified by utilizing an interaural cross-correlation function, it is difficult to determine whether the sound image exists in the forward direction or in the rearward direction because of the properties of the interaural cross-correlation function. For example, a result of calculating an interaural cross-correlation function for a binaural recording signal obtained by recording a sound from a sound source arranged in the direction of 45° has the same characteristics as a result of calculating an interaural cross-correlation function for a binaural recording signal obtained by recording the same sound from a sound source arranged in the direction of 135°. More specifically, in the case where the sound source is arranged in the direction of 0°, and the case where the sound source is arranged in the direction of 180°, the peak time is 0 msec in both cases. In the case where the sound source is arranged in the direction of 45°, and the case where the sound source is arranged in the direction of 135°, the peak time is about 0.4 msec in both cases. In the case where the sound source is arranged in the direction of 90°, the peak time is about 0.8 msec. In the case where the sound source is arranged in the direction of 225°, and the case where the sound source is arranged in the direction of 315°, the peak time is about −0.4 msec in both cases. In the case where the sound source is arranged in the direction of 270°, the peak time is about −0.8 msec.

In the sound-image localization utilizing human auditory misperception, it is sufficient if the sound-image direction can be presented to the user in units of 45°. Furthermore, as described above, when a sound-image direction is to be specified by utilizing an interaural cross-correlation function, it is difficult to determine whether the sound image exists in the forward direction or in the rearward direction. Accordingly, candidates for the sound-image directions to be presented to the user include the following five directions; the front (including rear), diagonally left (including diagonally forward left and diagonally rearward left), the left side, diagonally right (including diagonally forward right and diagonally rearward right), and the right side. In this embodiment, in association with these five directions, five time ranges indicated by the following formulas (2) to (6) are set. The time range indicated by formula (2) corresponds to the front (0° or 180°), the time range indicated by formula (3) corresponds to diagonally left (45° or 135°), the time range indicated by formula (4) corresponds to the left side) (90°, the time range indicated by formula (5) corresponds to diagonally right (225° or 315°), and the time range indicated by formula (6) corresponds to the right side (270°). The peak time τ corresponds to a time difference between both ears, and changes depending on the incident angle. Accordingly, the time ranges for the directions become uneven. Furthermore, people are sensitive to determining whether a sound comes from the direct front or from the direct rear, and tend to determine that the sound-image direction is diagonal with respect to sounds from other directions, and thus, with respect to diagonal directions, wide ranges are set as indicated by formula (3) and formula (5).

−0.08 msec<τ(i)<0.08 msec (2)

0.08 msec≦0.6 msec (3)

0.6 msec≦1 msec (4)

−0.6 msec<τ(i)≦−0.08 msec (5)

−1 msec<τ(i)≦−0.6 msec (6)

The determination unit 103 detects a signal zone (localized-sound zone) in which a sound image is localized in a binaural recording signal based on peak times. In one example, the determination unit 103 determines that a signal zone, in which peak times of a number greater than or equal to a predetermined number are consecutively included in one of a plurality of (five in this embodiment) time ranges determined in advance, is a localized-sound zone. As the localized sound, for example, the sound effects of a call of an animal, a door opening/closing, footstep sounds, a warning beep, and the like are assumed. The duration time of such sound effects is one sec. to 10 sec. at the longest. Accordingly, the determination unit 103 detects, for example, a signal zone of a duration time of 1 sec. or longer in which the sound-image direction does not change as a localized-sound zone. In an example in which an interaural cross-correlation function is calculated at time intervals of 0.1 sec., when consecutive peak times of a number greater than or equal to ten belong to the same time range, it is determined that a signal zone corresponding to these peak times is a localized-sound zone. For example, when all of consecutive peak times τ(5) to τ(20) have values in the time range indicated by formula (3), it is determined that a signal zone from 0.5 sec. to 2.0 sec. is a localized-sound zone. In this example, the sound-image direction in the localized-sound zone is diagonally left.

It should be noted that not only when all of consecutive peak times τ are included in any one of time ranges, but also when a few of peak times τ in the middle of consecutive peak times are included in another time range, the determination unit 103 may determine that a signal zone corresponding to these peak times is a localized-sound zone. By referring to the above-mentioned example, it is possible to consider that peak times τ(5) to τ(20) are consecutively included in any one of time ranges even when, for example, peak times τ(15), and τ(16) belong to a time range different from peak times τ(5) to τ(14) and peak times τ(17) to τ(20). At this time, the number of a few peak times τ allowed to be included in another time range in order that a signal zone may be judged to be a localized-sound zone can be determined, for example, beforehand.

In this embodiment, determination of a localized-sound zone is carried out based on the peak time τ. The intensity level γ indicates, in general, the strength of a localization sensation, i.e., the degree of being able to clearly perceive a sound image. The lower the intensity level γ, the more difficult determining the sound-image direction becomes. However, in cases (1) to (4) shown below, a localization sensation can be perceived even when the intensity level γ is low. Accordingly, the intensity level γ does not constitute a necessary and sufficient condition for determination of a localized-sound zone unlike the peak time τ.

Case (1): a case where the sound effects have specific characteristics, e.g., a case where the sound pressure or frequency of a sound entering both ears varies as can be found in, for example, a call of an animal or a case where a vibrant sound of a can is added as is found in the sound of a can being kicked.

Case (2): a case where background noise or noise having no correlation with the sound effects is superimposed on the sound effects. For example, when a sound having no correlation with the localized sound is superimposed on the localized sound, only the denominator of the interaural cross-correlation function increases, and hence the intensity is lowered.

Case (3): a case where the characteristics of the environment (for example, characteristics of a room) in which the sound effects are recorded are added to the sound effects. For example, when a sound of footsteps is recorded in a church, reverberations are naturally convoluted into the footsteps, and are recorded together.

Case (4): a case where a sound source is nearing from a certain direction or a sound source is moving away in a certain direction. Due to the distance attenuation effect, both the left-ear sound pressure P_{L}, and right-ear sound pressure P_{R} increase or decrease with time, and hence the influence of the background sound which has hitherto been negligible is added to both the sound pressures, whereby the intensity changes.

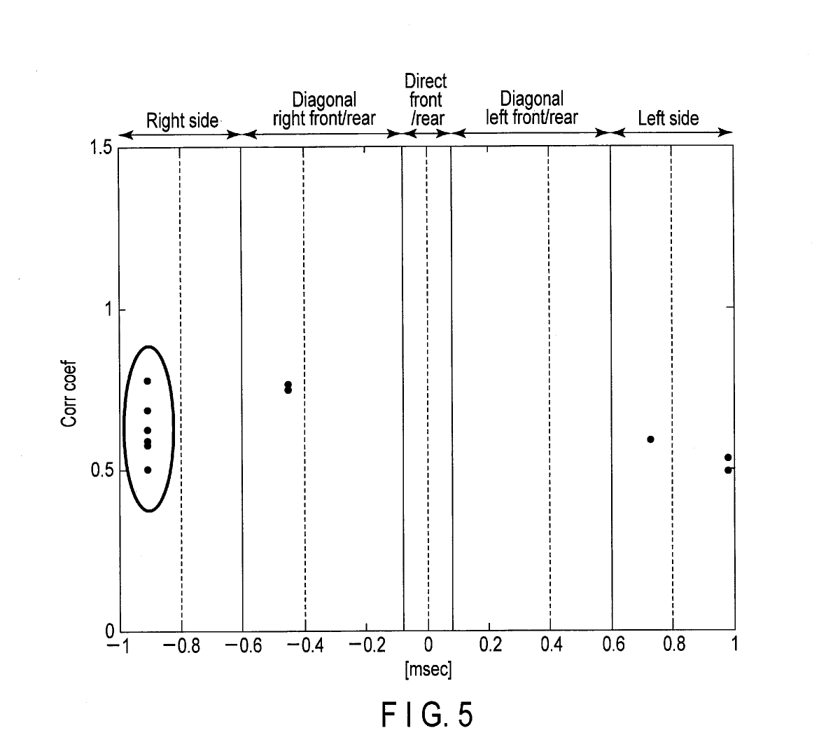

FIGS. 5 to 11 show results of calculating interaural cross-correlation functions of sound effects from which a localization sensation can be perceived although the intensity level is low.

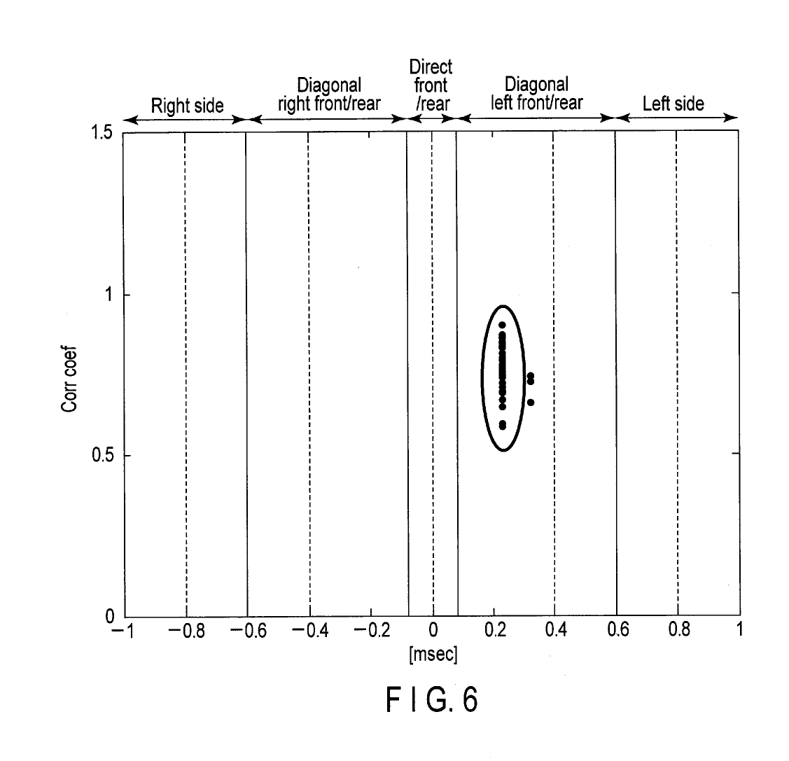

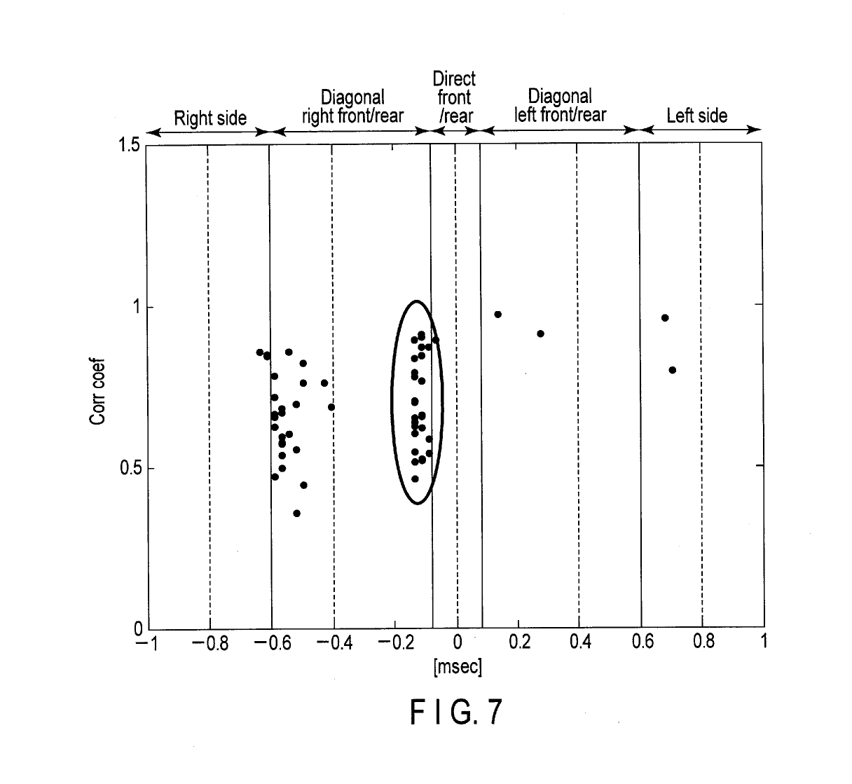

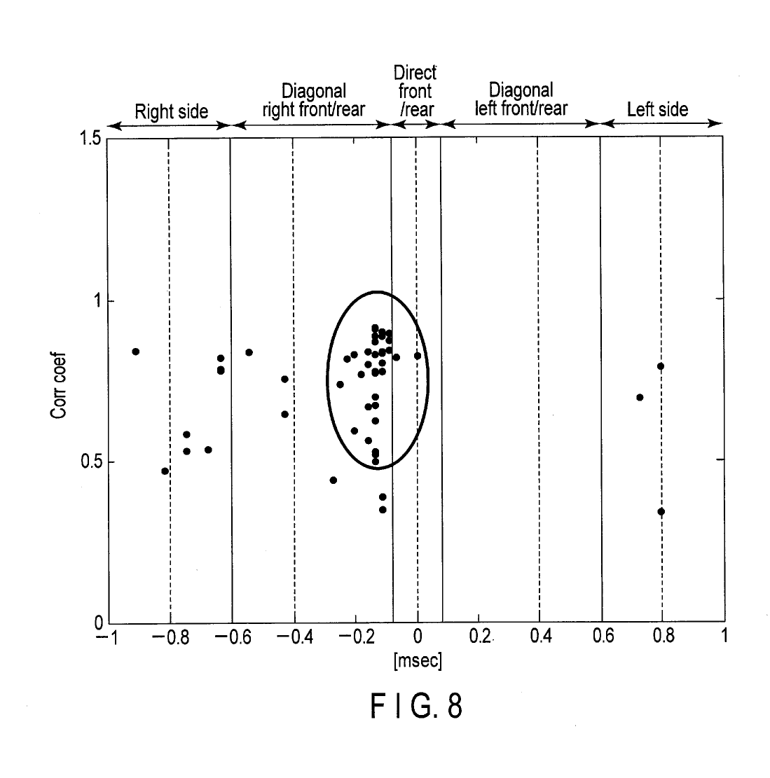

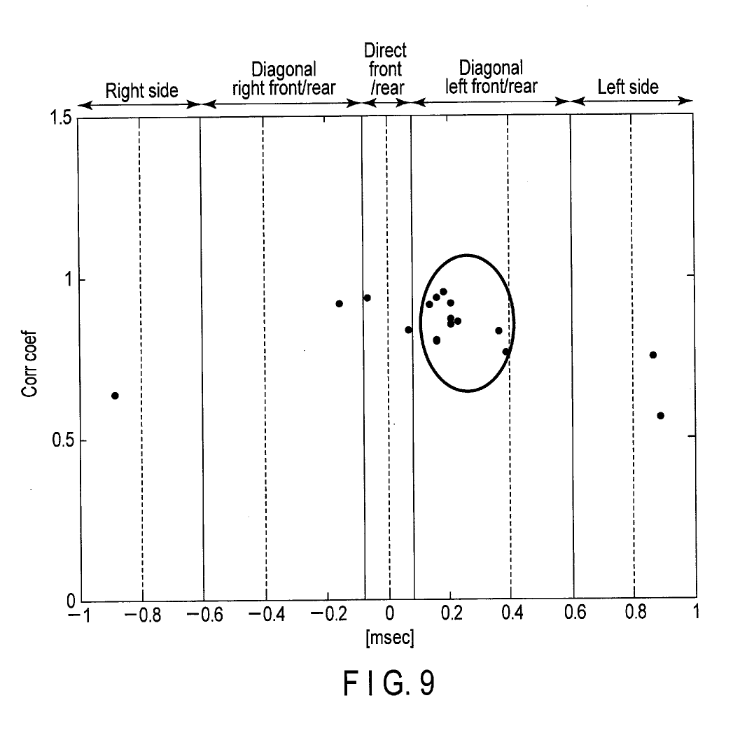

FIG. 5 shows a result of an analysis of a signal obtained by recording a ringing sound of a telephone positioned on the right side. In FIG. 5, there is absolutely no background sound, the ringing sound is dominant, and the intensity level thereof changes with the change in the tone. FIG. 6 shows a result of an analysis of a signal obtained by recording a sound of a hair drier in operation positioned to the left rear. In FIG. 6, there is absolutely no background sound, the sound of the fan is dominant, and the intensity level thereof increases with an increase in the noise. FIG. 7 shows a result of an analysis of a signal obtained by recording a sound generated when a door positioned diagonally rearward right is opened. In FIG. 7, the part surrounded by a line indicates data points corresponding to the sound generated by the door when it is opened. The examples of FIGS. 5 to 7 correspond to Case (1). FIG. 8 shows a result of an analysis of a signal obtained by recording a conversation perceived in the diagonally rearward right direction. In FIG. 8, the part surrounded by a line indicates data points corresponding to the conversation. Although among the consecutive data points, two points exist in the front area, even when these two points are excluded, the diagonally rearward right direction can be recognized. FIG. 9 shows a result of an analysis of a signal obtained by recording a conversation sound similar to a whisper of a woman in the diagonally rearward left direction. In FIG. 9, the part surrounded by a line indicates data points corresponding to the conversation, and the sound volume of the conversation is small, and hence variations in intensity level are caused by the influence of the ambient noise. The examples of FIG. 8 and FIG. 9 correspond to Case (2).

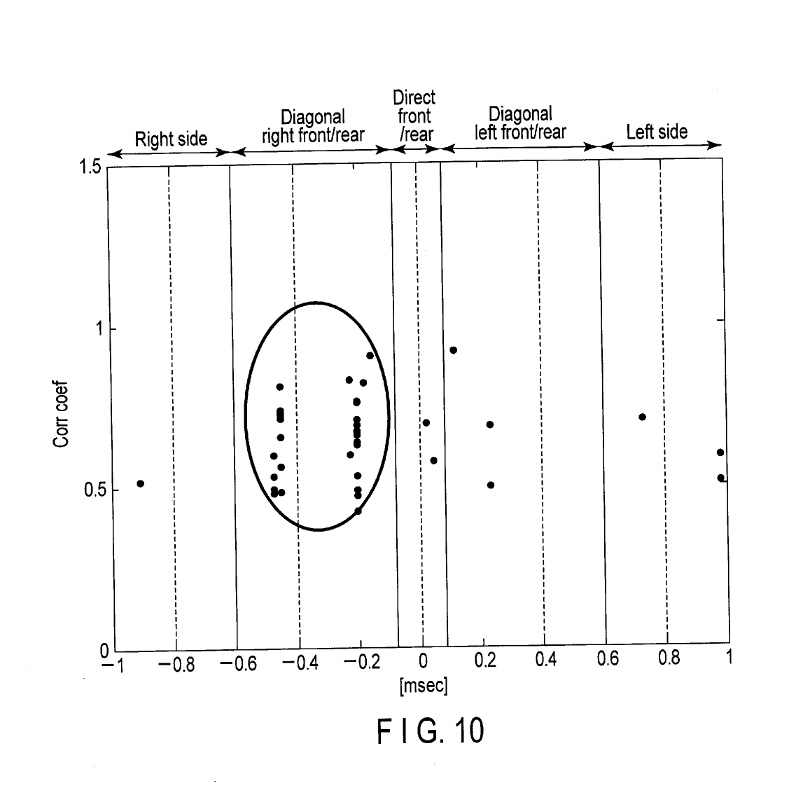

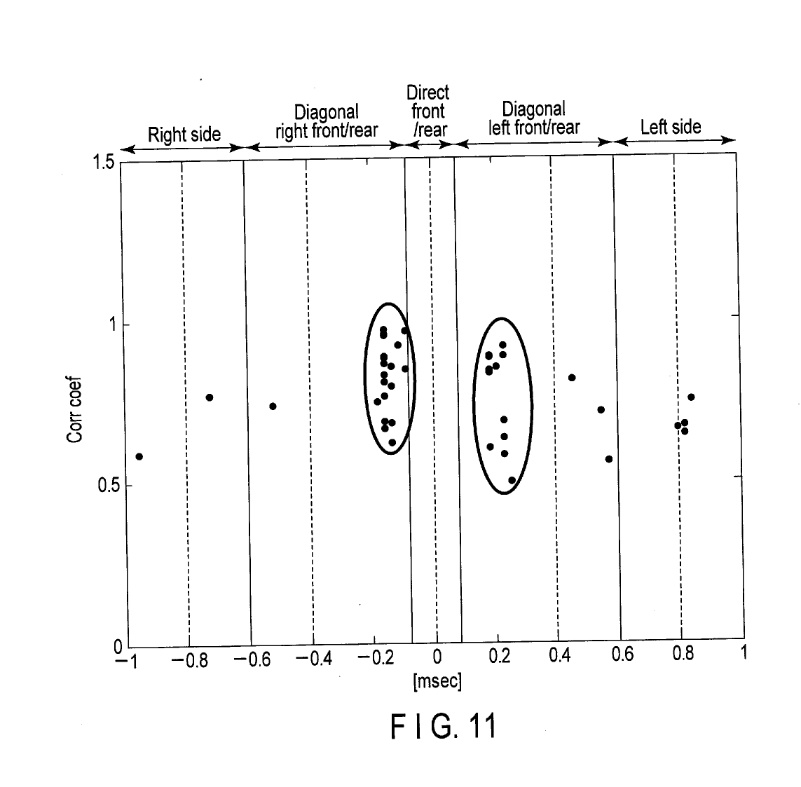

FIG. 10 shows a result of an analysis of a signal obtained by recording a sound of footsteps generated in the diagonally rearward right direction in a church. The part surrounded by a line indicates data points corresponding to the footsteps. Among a chain of data points of footsteps moving away in the same direction, the first half corresponds to a sound near −0.2 msec, and the latter half corresponds to a sound near −0.5 msec. Both of them are sounds having a reverberation sensation, and with variations in intensity level emanating from them. The example of FIG. 10 corresponds to Case (3). FIG. 11 shows a result of an analysis of a signal obtained by recording a sound of footsteps nearing from the diagonally forward left direction, and sound of a can being kicked generated at a diagonally forward right position. Although the sound-source position of the sound of a can being kicked does not move, the sound is accompanied by an echo, and hence there are variations in intensity level. The example of FIG. 11 corresponds to Case (4).

Next, examples of a sound which is not judged to be a localized sound will be described below.

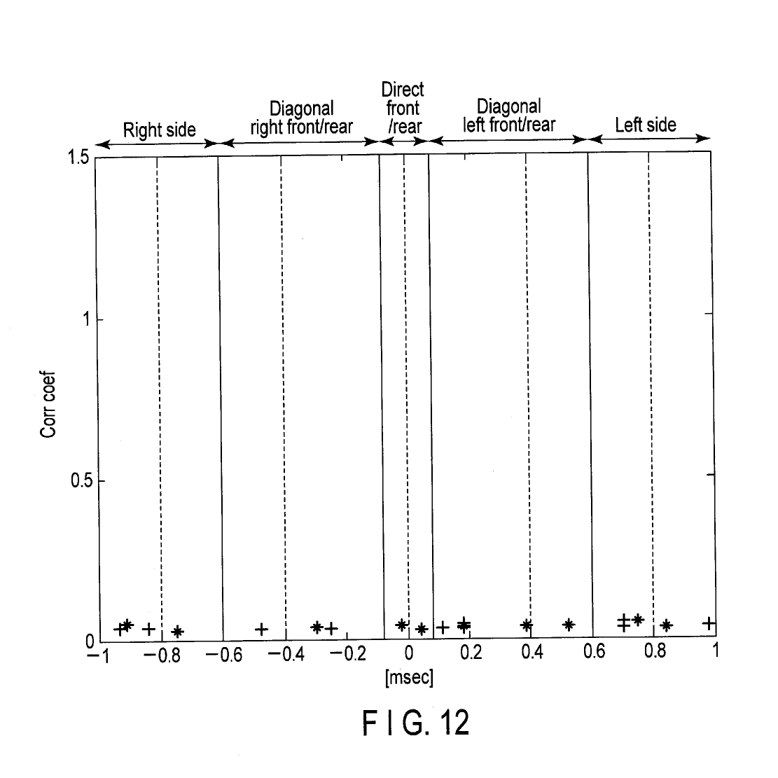

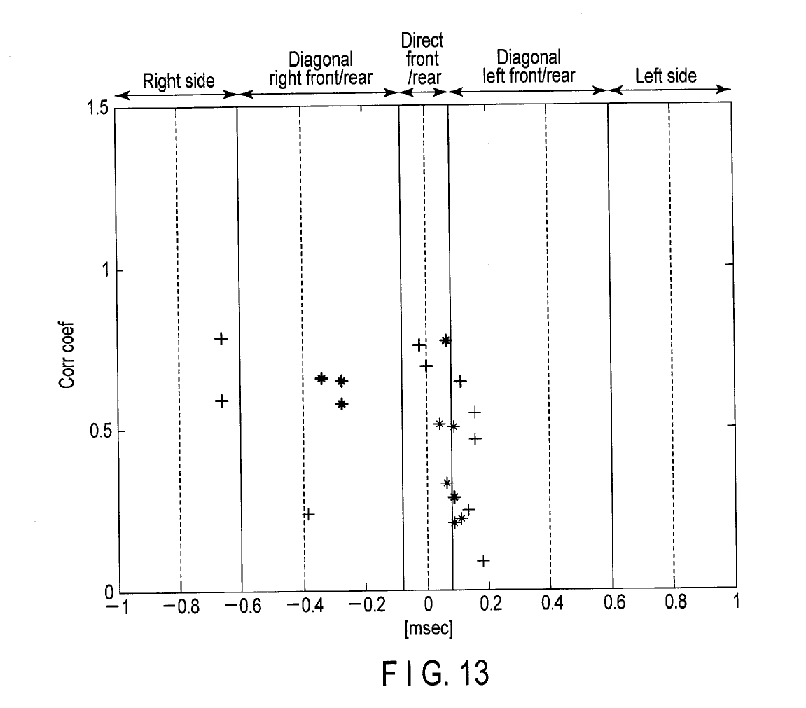

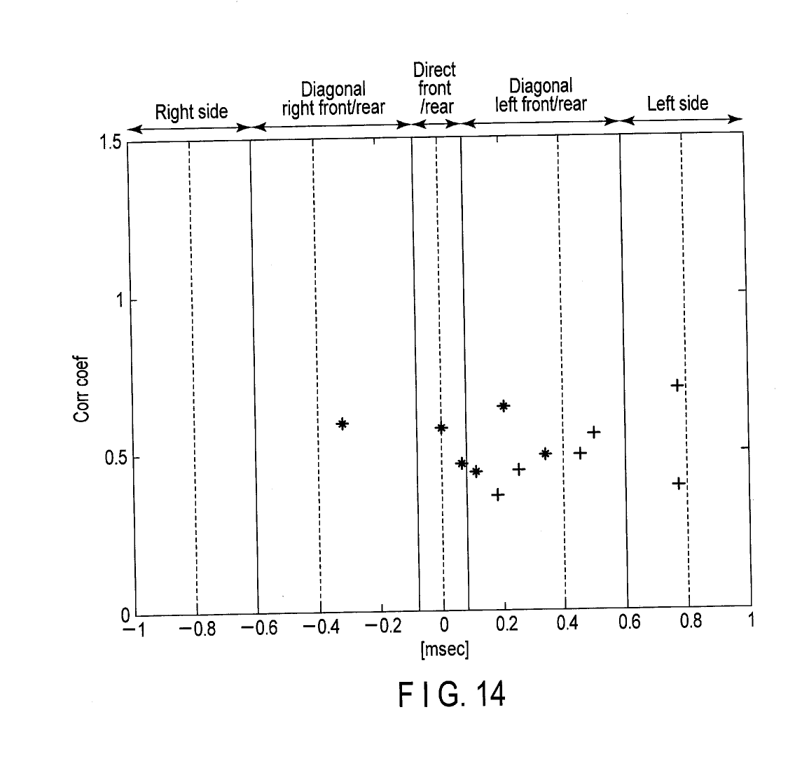

FIG. 12 shows a result of an analysis of uncorrelated random signals (for 10 sec.) of two channels. In FIG. 12, an interaural cross-correlation analysis is carried out at intervals of 0.5 sec., and data points in the first half 5 sec. are expressed by “*”, and data points in the latter 5 sec. are expressed by “+”. From FIG. 12, it can be seen that when the signals are completely uncorrelated, the direction varies, and the intensity level is low. FIG. 13 shows a result of an analysis of a signal (for 4 sec.) obtained by recording background noise in front of a pedestrian crossing. In FIG. 13, an interaural cross-correlation analysis is carried out at intervals of 0.2 sec., and data points from 0.2 sec. to 1 sec., and data points from 2.2 sec. to 3 sec. are expressed by “*”, and data points from 1.2 sec. to 2 sec., and data points from 3.2 sec. to 4 sec. are expressed by “+”. In this example, both the direction and intensity level vary. FIG. 14 shows a result of an analysis of a signal (for 6 sec.) obtained by recording background noise on the streets. In FIG. 14, an interaural cross-correlation analysis is carried out at intervals of 0.5 sec., and data points in the first 3-second interval are expressed by “*”, and data points in the latter 3-second interval are expressed by “+”. In this example too, both the direction and intensity level vary.

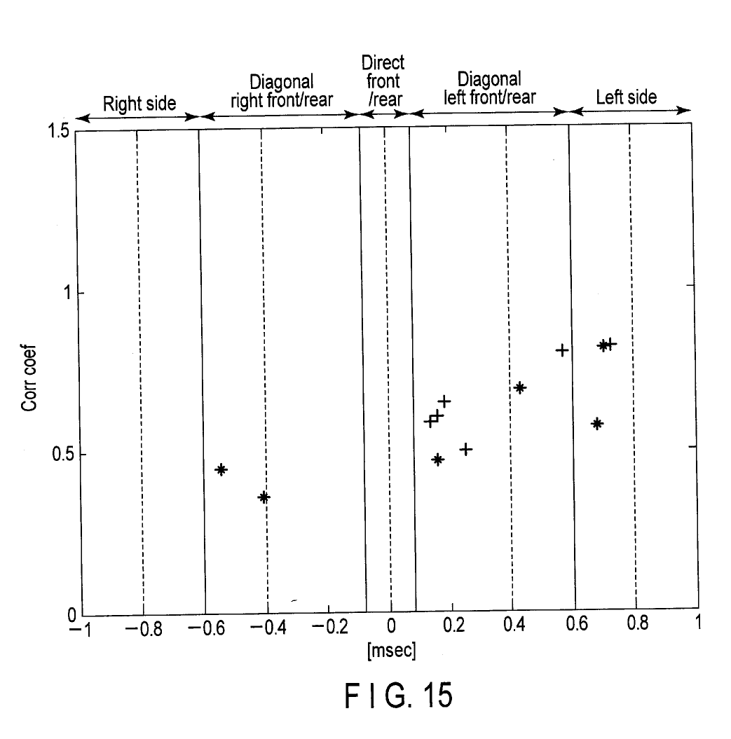

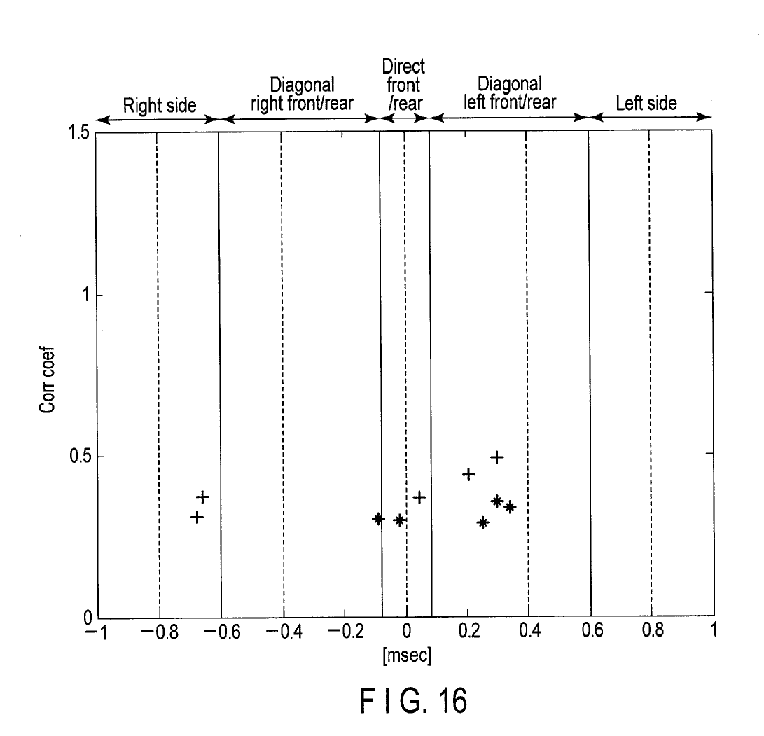

FIG. 15 shows a result of an analysis of a signal (for 6 sec.) obtained by recording a sound of a bike crossing an intersection just ahead from right to left. In FIG. 15, an interaural cross-correlation analysis is carried out at intervals of 0.5 sec., and data points in the first 3-second interval are expressed by “*”, and data points in the latter 3-second interval are expressed by “+”. In this example, although a localization sensation of a sound image moving from side to side can be perceived, the direction largely varies, and lowering of the sound pressure due to distance attenuation occurs. Such a moving sound image is not treated as a localized sound, but as a background sound. FIG. 16 shows a result of an analysis of a signal (10 sec.) obtained by recording a sound of two seaside waves. In FIG. 16, an interaural cross-correlation analysis is carried out at intervals of 0.5 sec., and data points in the first 5-second interval are expressed by “*”, and data points in the latter 5-second interval are expressed by “+”. In this example, both the direction and intensity level vary.

It should be noted that the determination unit 103 may carry out determination of a localized-sound zone based on a combination of the peak times and the intensity levels. More specifically, the determination unit 103 determines that a signal zone, in which peak times of a number greater than or equal to a predetermined number are consecutively included in one of time ranges, and intensity levels of a number greater than or equal to a predetermined number are consecutively greater than or equal to a predetermined threshold, is a localized-sound zone. For example, when all of peak times τ(5) to τ(14) fall within the time range indicated by formula (3), and all of intensity levels γ(5) to γ(14) are greater than or equal to a threshold (for example, 0.5), a signal zone from 0.5 sec. to 1.4 sec. is determined to be a localized-sound zone.

It should be noted that that intensity levels of a number greater than or equal to a predetermined number are consecutively greater than or equal to a predetermined threshold may include a case where several intensity levels in the middle are less than the predetermined threshold. For example, in the case where although intensity levels γ(5) to γ(10), and γ(12) to γ(14) are equal to or greater than a threshold (for example, 0.5), an intensity level γ(11) is smaller than the threshold, it is possible to regard the intensity levels γ(5) to γ(14) as being consecutively equal to or greater than the threshold. At this time, the number of several intensity levels allowed to be smaller than the threshold in order that the signal zone may be determined to be a localized-sound zone can be determined beforehand.

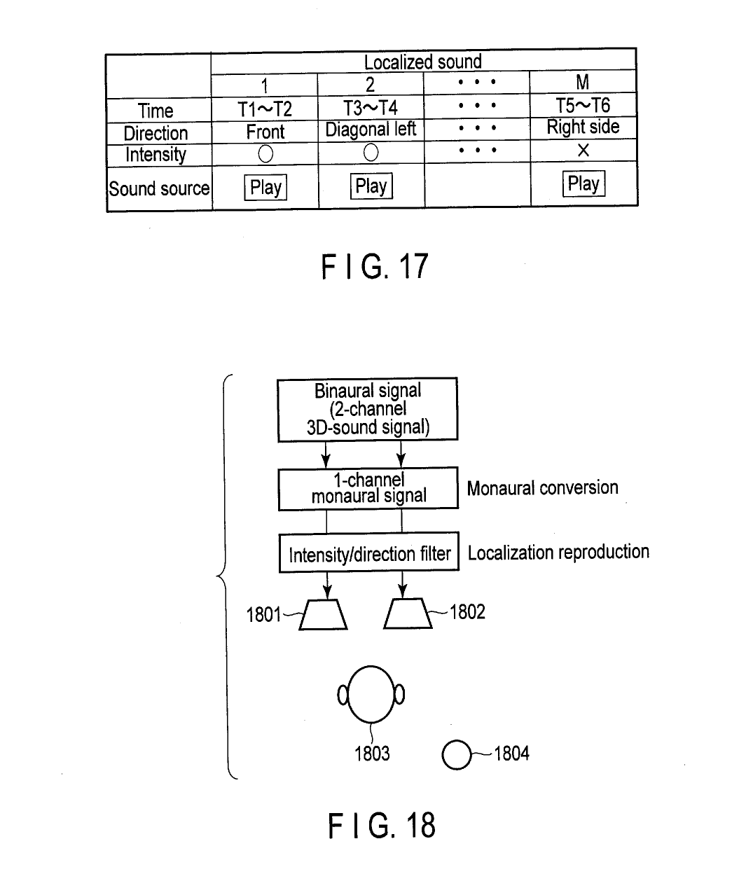

The display unit 104 displays information associated with the determination result of the determination unit 103. FIG. 17 shows an example of a screen for displaying information associated with a localized-sound zone. In the example of FIG. 17, a display screen of a case where M localized-sound zones are detected is shown, and the time, sound-image direction, and intensity are described for each localized sound. In the column of intensity, “◯” indicates that the intensity level is high, and “x” indicates that the intensity level is low. Here, although the intensity is evaluated by two levels, the intensity may also be evaluated by three or more levels by setting a plurality of thresholds. When the user selects, for example, a play button in the column of the localized sound 1 by using the input unit 107, a binaural recording signal of the time zone T1 to T2 is reproduced.

The localized-sound extraction unit 106 extracts a localized-sound component from a content sound included in a localized-sound zone to thereby generate an extracted localized-sound signal (two-channel binaural audio signal). For example, when there are M localized-sound zones, M extracted localized-sound signals are generated. The background-sound extraction unit 105 extracts a background-sound component included in a localized-sound zone in the binaural recording signal to thereby generate a background-sound signal (two-channel binaural audio signal). This background-sound signal corresponds to a signal obtained by removing an extracted localized-sound signal from a binaural recording signal. That is, a content sound is a sound obtained by adding a background sound to a localized sound in a superimposing manner. If a content sound in a specific signal zone is targeted, the technique for separating/extracting different types of sounds is known to the public. The localized-sound extraction unit 106 and the background-sound extraction unit 105 can separate a localized sound and background sound from each other in a localized-sound zone by utilizing, for example, this publicly known technique.

The input unit 107 receives an instruction from the user. The user can instruct whether or not to redefine a localized sound by using the input unit 107. Redefining implies changing at least one of a direction (sound-image direction) in which a sound image is to be localized, and a degree of emphasis (emphasis degree) of a localization sensation of a sound image. For example, the user can specify a sound-image direction, and an emphasis degree for each of the localized sounds displayed on the display screen.

The signal generator 108 generates a localized-sound signal based on the sound-image direction and the emphasis degree specified by the user. In one example, as shown in FIG. 18, the signal generator 108 converts an extracted localized-sound signal extracted by the localized-sound extraction unit 106 into a monaural signal to thereby generate a localized-sound monaural signal. For example, it is possible to use an average of a left signal and a right signal included in an extracted localized-sound signal, or one of these signals as a localized-sound monaural signal. Then, the signal generator 108 generates a localized-sound signal (two-channel binaural audio signal) based on the sound-image direction, the emphasis degree specified by the user, and the localized-sound monaural signal. Specifically, the signal generator 108 retains a plurality of sound transmission characteristics, each of which is made to correspond to a sound-image direction and an emphasis degree, and selects a sound transmission characteristic most appropriate for the specified sound-image direction and emphasis degree from these sound transmission characteristics, and carries out a convolution operation of convoluting the selected sound transmission characteristic into the localized-sound monaural signal, thereby obtaining a localized-sound monaural signal to which information on localization in the front-rear direction and an emphasis degree are imparted. Furthermore, the signal generator 108 imparts an intensity difference and a time difference between both ears to the localized-sound monaural signal to thereby generate a localized-sound signal to which information on localization in the right-left direction is imparted. The signal generator 108 adds the generated localized-sound signal to a background-sound signal extracted by the background-sound extraction unit 105 in a superimposing manner. It should be noted that a localized-sound signal, corresponding to a localized sound for which no redefinition instruction has been issued, is added as-is to the background-sound signal in a superimposing manner. Thereby, a binaural audio signal in which a sound image is localized in the direction desired by the user is generated. The signal generator 108 outputs the generated binaural audio signal to the output unit 109 (for example, speakers, earphones, or the like), and the user can listen to a redefined content sound by the output unit 109. When a binaural audio signal is reproduced in both ears of the listener by using two speakers 1801 and 1802 as the output unit 109, control filter processing for cancelling crosstalk is required. A control filter coefficient is determined based on four head-related transfer functions from the speakers 1801 and 1802 to both ear positions of the listener 1803. In FIG. 18, the circular mark 1804 indicates the position of the sound image.

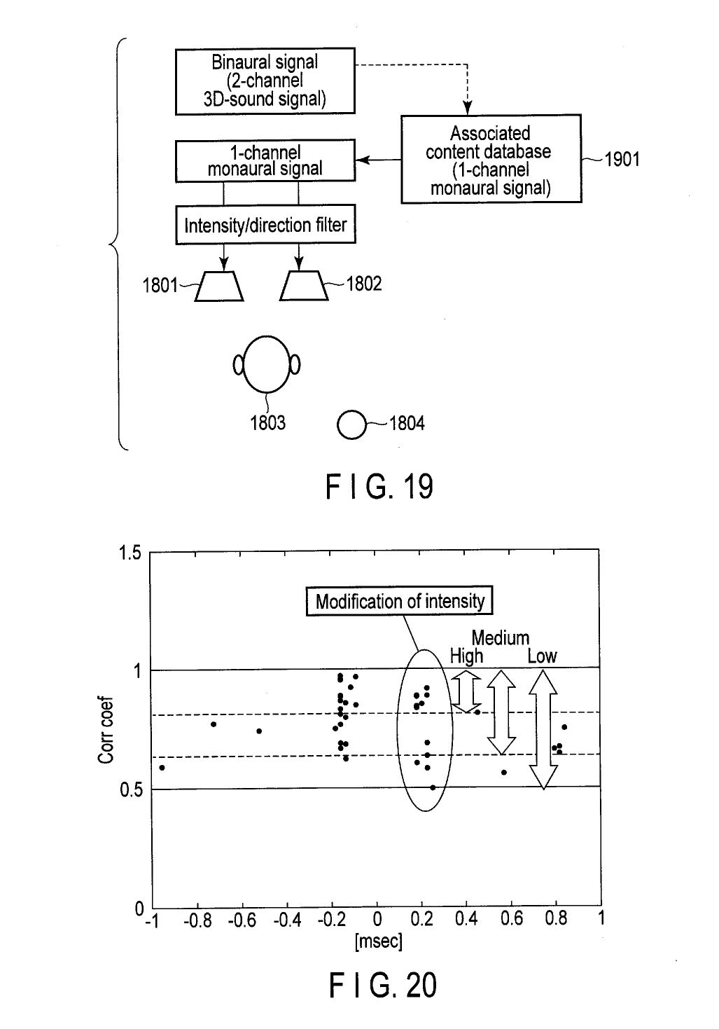

In another example, as shown in FIG. 19, the signal generator 108 retains an associated content database (DB) 1901 configured to store therein associated content sound signals (one-channel monaural signals) recorded and signal-processed by video/audio engineers, and generates a binaural audio signal by using the associated content sound signal stored in the associated content DB 1901 in place of a localized-sound signal extracted by the localized-sound extraction unit 106. In this example, the processing is identical to the above-mentioned processing except for the fact that the associated content sound signal is used in place of the localized-sound signal, and hence the description thereof is omitted.

FIG. 20 shows an example of a method of specifying the emphasis degree. FIG. 20 shows an example in which the emphasis degree is selected from three levels (low, medium, and high). When “low” is selected, a binaural audio signal with the intensity of 0.5 or more, for example, is generated. When “medium” is selected, a binaural audio signal with the intensity of 0.65 or more, for example, is generated. When “high” is selected, a binaural audio signal with the intensity of 0.8 or more, for example, is generated. It should be noted that, in another example, the user may specify an emphasis degree indicating whether or not the localization sensation of the localized sound is to be emphasized. When an emphasis degree indicating that the localization sensation is to be emphasized is specified, a binaural audio signal is generated in such a manner that the intensity becomes higher than or equal to a predetermined value (for example, 0.5).

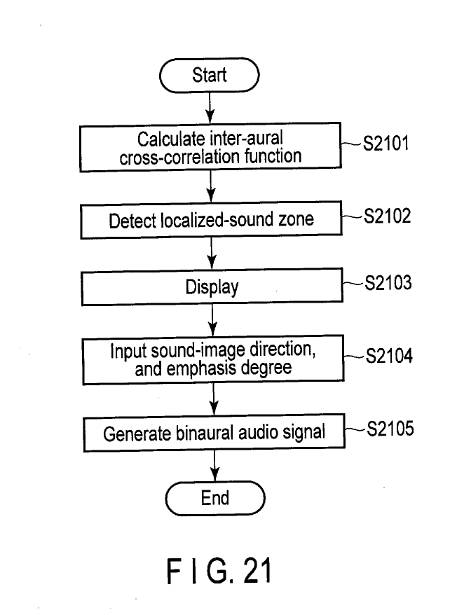

FIG. 21 schematically shows a processing procedure of the audio control apparatus 100 according to this embodiment. In step S2101 of FIG. 21, the calculation unit 102 calculates an interaural cross-correlation function of a binaural recording signal at regular time intervals. In step S2102, the determination unit 103 detects a localized-sound zone in the binaural recording signal based on peak times at which the interaural cross-correlation functions calculated by the calculation unit 102 take the maximum values. In one example, the determination unit 103 determines that a signal zone, in which peak times of a number greater than or equal to a predetermined number are consecutively included in one of a plurality of time ranges determined in advance, is a localized-sound zone. In another example, the determination unit 103 determines that a signal zone, in which peak times of a number greater than or equal to a predetermined number are consecutively included in one of a plurality of time ranges determined in advance, and intensity levels of a number greater than or equal to a predetermined number are consecutively greater than or equal to a predetermined threshold, is a localized-sound zone.

In step S2103, the display unit 104 displays information which includes sound-image direction and intensity information with respect to the localized-sound zone detected by the determination unit 103. In step S2104, the user specifies a desired sound-image direction and emphasis degree with respect to the localized sound by using the input unit 107. In step S2105, the signal generator 108 generates a new localized-sound signal based on the specified sound-image direction, emphasis degree, and a localized-sound signal extracted from a corresponding localized-sound zone, and adds the generated localized-sound signal to the background-sound signal in a superimposing manner. Thereby, a binaural audio signal in which a sound image is localized in the direction desired by the user is generated.

As described above, the audio control apparatus according to this embodiment calculates an interaural cross-correlation function of a binaural recording signal at regular time intervals, and detects a signal zone in which the sound-image direction does not change for a predetermined time or more in the binaural recording signal as a localized-sound zone. Thereby, it is possible to easily detect a localized-sound zone in a binaural recording signal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An audio control apparatus comprising:
a calculation unit configured to calculate an interaural cross-correlation function of a binaural recording signal at regular time intervals; and
a determination unit configured to determine that a signal zone in which peak times of interaural cross-correlation functions are consecutively included in one of a plurality of time ranges determined in advance is a localized-sound zone in which a sound-image is localized, each of the peak times being a time at which a corresponding cross-correlation function takes a maximum value.

2. The apparatus according to claim 1, wherein the determination unit is configured to determine that a signal zone in which peak times of interaural cross-correlation functions are consecutively included in one of the time ranges and maximum values of the interaural cross-correlation functions are consecutively greater than or equal to a threshold is the localized-sound zone.

3. The apparatus according to claim 1, further comprising a localized-sound extraction unit configured to extract a localized sound from a content sound included in the localized-sound zone.

4. The apparatus according to claim 3, further comprising an input unit configured to receive a user input specifying a sound-image direction indicating a direction in which the localized sound is to be localized.

5. The apparatus according to claim 4, further comprising a signal generator configured to generate a localized-sound signal corresponding to the localized-sound zone based on the sound-image direction.

6. The apparatus according to claim 3, further comprising an input unit configured to receive a user input specifying an emphasis degree indicating a degree of emphasis of a localization sensation of the localized sound.

7. The apparatus according to claim 3, further comprising an input unit configured to receive a user input specifying an emphasis degree indicating whether or not the localization sensation of the localized sound is to be emphasized.

8. The apparatus according to claim 6, further comprising a signal generator configured to generate a localized-sound signal corresponding to the localized-sound zone based on the emphasis degree.

9. The apparatus according to claim 5, further comprising an output unit configured to output a binaural audio signal generated based on the generated localized-sound signal.

10. The apparatus according to claim 1, further comprising a display unit configured to display a direction in which a localized sound is localized and an intensity level indicating a localization sensation of the localized sound for the localized-sound zone.

11. An audio control method comprising:
calculating aninteraural cross-correlation function of a binaural recording signal at regular time intervals; and
determining that a signal zone in which peak times of interaural cross-correlation functions are consecutively included in one of a plurality of time ranges determined in advance is a localized-sound zone in which a sound-image is localized, each of the peak times being a time at which a corresponding cross-correlation function takes a maximum value.

12. The method according to claim 11, wherein the determining comprises determining that a signal zone in which peak times of interaural cross-correlation functions are consecutively included in one of the time ranges and maximum values of the interaural cross-correlation functions are consecutively greater than or equal to a threshold is the localized-sound zone.

13. The method according to claim 11, further comprising extracting a localized sound from a content sound included in the localized-sound zone.

14. The method according to claim 13, further comprising receiving a user input specifying a sound-image direction indicating a direction in which the localized sound is to be localized.

15. The method according to claim 14, further comprising generating a localized-sound signal corresponding to the localized-sound zone based on the sound-image direction.

16. The method according to claim 13, further comprising receiving a user input specifying an emphasis degree indicating a degree of emphasis of a localization sensation of the localized sound.

17. The method according to claim 13, further comprising receiving a user input specifying an emphasis degree indicating whether or not the localization sensation of the localized sound is to be emphasized.

18. The method according to claim 16, further comprising generating a localized-sound signal corresponding to the localized-sound zone based on the emphasis degree.

19. The method according to claim 15, further comprising outputting a binaural audio signal generated based on the generated localized-sound signal.

20. The method according to claim 11, further comprising displaying a direction in which a localized sound is localized and an intensity level indicating a localization sensation of the localized sound for the localized-sound zone.
